(19) United States
(12) Patent Application Publication
(10) Pub. No.: US 2025/0002125 A1
(43) Pub. Date: Jan. 2, 2025

(54) RENEWABLE ENERGY PLATFORM ASSEMBLY KIT AND METHOD

(71) Applicant: MARINE POWER SYSTEMS LIMITED, Swansea South Wales (GB)

(72) Inventor: Graham FOSTER, Swansea South Wales (GB)

(73) Assignee: MARINE POWER SYSTEMS LIMITED, Swansea South Wales (GB)

(21) Appl. No.: 18/830,159

(22) Filed: Sep. 10, 2024

Related U.S. Application Data
(63) Continuation of application No. PCT/EP2023/056973, filed on Mar. 17, 2023.

(30) Foreign Application Priority Data
Mar. 18, 2022 (GB) 2203823.6

(51) Int. Cl. B63B 75/00; B63B 35/44; F03B 13/14; F03D 13/25

(52) U.S. Cl. CPC B63B 75/00; B63B 2035/446; B63B 2035/4466; F03B 13/14; F03D 13/25; F05B 2240/93

(57) ABSTRACT

An assembly kit for an offshore renewable energy system mounting platform having a frame with three or more lateral braces; upright braces and vertex members with each vertex member coupled to the lateral braces such that the lateral braces and the vertex members form a substantially planar base of the frame. The vertex members each engage a first end of a corresponding upright brace affixing the upright brace to the base, The frame includes a transition piece engaging a second end of the upright braces to form a fixed apex of the frame. The kit includes a plurality of lateral brace supports and a vertical tower. Each of the lateral brace supports are on a horizontal plane above the ground and the vertical tower is positioned to engage the upright braces such that each engaged upright brace is supported at an upright angle.

### CROSS REFERENCE TO RELATED APPLICATIONS

This continuation application claims priority benefit from International Application No. PCT/EP2023/056973 filed on Mar. 17, 2023, which claimed priority from Great Britain Application No. 2203823.6 filed Mar. 18, 2022, which are both incorporated herein by reference in their entirety.

### FIELD OF THE INVENTION

The present disclosure relates to a renewable energy system mounting platform, and in particular to assembly kit for a platform arranged to support a renewable energy harnessing device in a body of water, and a method of manufacturing such a platform.

### BACKGROUND OF THE INVENTION

The world is transitioning to renewable energy—this transition will require the exploitation of all forms or renewable energy to provide the planet with energy it needs.

One potential renewable energy source is wave power—an abundant and consistent energy resource available in all the world's large oceans and seas. Another is wind power, with wind speeds being higher and more consistent over oceans and seas compared to land.

For these reasons, offshore platforms providing means to mount renewable energy devices which harness wave and/or wind power in deep water are required.

The cost of the platforms and their assembly directly influences the cost of energy produced by the devices therefore there is a need for platforms that are cost effective to manufacture and assemble.

In particular there is a need for platforms that can been manufactured as a set of pre-fabricated modular components in a wide supply chain, which are subsequently assembled into the complete platform at non-specialist outdoor yard facilities without the need for specialist shipbuilding facilities, and which does not compromise on stability when deployed.

### SUMMARY OF THE INVENTION

The present invention provides an assembly kit for an offshore renewable energy system mounting platform for positioning a renewable energy converter in a body of water, the platform comprising a plurality of discrete pre-fabricated components which are assembled with the use of assembly aids. The assembly aids act to enable swift and simplified assembly of the discrete pre-fabricated components of the platform, in a manner which reduces the requirement for additional costly heavy machinery such as cranes, which can make aligning components for connection difficult. The assembly aids also reduce the need for scaffolding, the assembly and disassembly of which can add considerable time to platform assembly. The assembly aids also preferably act to hold the prefabricated components of the platform in a stationary fashion in order to facilitate easy fixing or welding of components together, while also preferably providing easy access to joints for fixing or welding. The discrete components of the platform are preferably minimal in number and in type in order to simplify manufacture, assembly and maintenance. The components are preferably manufactured such that they interact at simple temporary mating connections which hold the components together with the assistance of the assembly aids, during a stepwise assembly process optionally prior to a permanent fixing, such as welds, being applied to reinforce said mating connections and provide rigidity to the frame.

In accordance with a first aspect of the present invention, there is provided an assembly kit for assembling an offshore renewable energy system mounting platform, the kit comprising: a frame for a renewable energy system mounting platform, the frame comprising: three or more elongate lateral braces; a plurality of elongate upright braces, equal to the quantity of lateral braces; a plurality of vertex members equal to the quantity of lateral braces, each vertex member arranged to affix two said lateral braces at a corresponding end thereof such that the lateral braces and the vertex members form a substantially planar base of the frame; and wherein the vertex members are each further arranged to engage a first end of a corresponding upright brace such that said upright brace is affixed to the base at an upright angle relative thereto; the frame further comprising a single transition piece arranged to engage a second end of each of the upright braces when positioned at said upright angle, the transition piece thereby forming a fixed apex of the frame, to form an assembled frame; the kit further comprising assembly aids, the assembly aids comprising: a plurality of lateral brace supports corresponding to the quantity of lateral braces; and a vertical tower; wherein each of the lateral brace supports comprise a lateral brace engaging surface arranged to engage a corresponding lateral brace such that said lateral brace is supported on a horizontal plane above the ground; and the vertical tower having a plurality of upright brace engaging surfaces, each upright brace engaging surface of the tower positioned to engage a corresponding upright brace such that each engaged upright brace is supported by the upright brace engaging surface at the upright angle.

It will be understood that the number of lateral brace supports corresponding to the quantity of lateral braces may include any number of supports for each lateral brace. For example, the kit may comprise a single lateral brace support suitable for supporting each lateral brace, and may be positioned at the centre along a length of the lateral brace during platform assembly. In other preferable embodiments there may be two or more lateral brace supports for each lateral brace, the supports arranged to be distributed along the length of the lateral brace during assembly. In embodiments comprising two lateral brace supports for each lateral brace, the lateral brace supports are preferably arranged to be positioned proximate each end of the corresponding lateral brace during assembly.

In preferable embodiments, the lateral brace engaging surface conforms to a shape of the corresponding lateral brace; and further wherein the upright brace engaging surface conforms to a shape of the corresponding upright brace. The lateral brace engaging surface and the upright brace engaging surface are therefore complimentary to the respective braces such that upon engagement, movement of the braces relative to the corresponding brace engaging surface is minimised. Such an engagement preferably therefore minimises movement of the braces during the application of a permanent fixing, such as welding, between the lateral braces and the vertex members, and the upright braces, the vertex members and the transition piece, therefore preferably simplifying assembly.

In most preferable embodiments, said shape of the lateral brace and said shape of the upright brace is one selected from the group: curved; cylindrical. A curved or cylindrical shape preferably offers stability against movement of the braces relative to the respective brace engaging surfaces, while maintaining optimal characteristics of the frame such as aerodynamic/hydrodynamic characteristics.

Other suitable forms of stable connection between the lateral braces and corresponding lateral brace engaging surfaces, and upright braces and upright brace engaging surfaces will be envisaged. Such forms of connection preferably involve complimentary mating surfaces and without the addition of complex locking mechanisms, preferably in order to minimise complexity and assembly duration.

In some preferable embodiments, the assembly aids further comprise vertex member supports corresponding to the quantity of vertex members, wherein each of the vertex member supports comprise a vertex member engaging surface arranged to engage a corresponding vertex member such that said vertex member is supported on a horizontal plane above the ground.

In some preferable embodiments, the assembly aids further comprise: one or more welding stations arranged to be positioned at each of the vertex members and the transition piece when engaged with said corresponding lateral braces or upright braces, each said lateral brace supported on a corresponding lateral brace support, each said upright brace supported on the vertical tower. Such welding stations may be arranged to support one or more welding personnel in a position optimal for welding joints between: the lateral braces and the vertex members; or the upright braces and a corresponding vertex member or the transition piece. In some embodiments, the assembly aids further comprise one or more habitat enclosures arranged to house the welding stations, the habitat enclosures comprising at least a roof positioned above said welding stations. In preferable embodiments, the habitat enclosures each further comprise a floor and sidewalls cooperating with said roof to enclose the welding stations in a welding space. It will be understood that the habitat enclosures additionally comprise doors for accessibility by welding personnel. The habitat enclosures are therefore preferably arranged to provide a safer welding environment protected from the weather or other site-related hazards including falling objects. In most preferable embodiments, the habitat enclosures are each arranged to surround a corresponding join between a lateral brace and a vertex member, or a corresponding join between an upright brace and the transition piece. The habitat enclosures are therefore preferably arranged to provide complete protection around the circumference of a lateral or upright brace joint during welding, while additionally improving accessibility to all areas of the joint for welding.

The assembly kit preferably further comprises a plurality of self-propelled modular transporter (SPMT) corresponding to the quantity of lateral braces, each SPMT arranged to support a corresponding lateral brace of the frame on a horizontal plane above the ground, and further arranged to, while engaged with said lateral brace, transport the assembled frame. In some embodiments, the lateral brace supports may be, or include, an SPMT. In some embodiments, therefore, each of the lateral brace supports may be arranged to, while engaged with said lateral brace, transport the assembled frame. The employment of SPMTs supporting each lateral brace preferably aids transport of the assembled frame from an assembly site, which may make availability of the assembly aids for the assembly of a subsequent platform frame. In some embodiments, each of the lateral braces is an SPMT.

The tower in some embodiments may further comprise an upper platform arranged to support assembly personnel.

In some embodiments, the transition piece is preferably arranged to support a renewable energy system thereon. In preferable embodiments, the renewable energy system comprises on or more of a wave energy converter; a wind turbine. In most preferable embodiments, the renewable energy system is a wind turbine.

In most preferable embodiments, the assembly kit comprises three said lateral braces. The three lateral braces therefore, in preferable embodiments, provide a planar triangular base. The assembly kit in such embodiments therefore comprises three upright braces and three vertex members. Such an arrangement of braces and vertex members therefore provides a platform frame having a tetrahedral shape. Such a conformation may preferably provide optimal stability while maintaining maximum simplicity. In use the platform preferably supports a renewable energy system thereon, such as a wind turbine or a wave energy harnessing device, the platform being deployed in a body of water in an in-use configuration. In such a configuration the platform is preferably tethered to a bed of the body of water at an offshore location, where the renewable energy device is arranged to harness sources of renewable energy for conversion to useful energy.

In most preferable embodiments, each of the lateral braces are identical, each of the upright braces are identical, and each of the vertex members are identical. Such a conformation preferably provides maximum simplicity for manufacture, assembly, and maintenance.

In preferable embodiments, each vertex member comprises two coplanar socket members each arranged to receive an end of a corresponding lateral brace on a common plane, and an angled socket member arranged to receive a first end of a corresponding upright brace at the upright angle relative to said plane. Embodiments will be appreciated wherein any suitable fixing between the lateral braces and the vertex members, and the upright braces and the vertex members is provided. For example, each of the lateral braces may instead comprise a socket at each end thereof, said socket arranged to receive a plug member of a corresponding vertex member, and the first ends of the upright braces may instead comprise a socket arranged to receive a plug member of a corresponding vertex member.

The assembly kit may preferably comprise a plurality of lateral brace supports for each corresponding lateral brace. In most preferable embodiments, two lateral brace supports are provided for each lateral brace, each of said pair of supports being arranged to be positioned proximate opposite ends of the corresponding lateral brace for optimal weight distribution and stability during assembly.

In accordance with a second aspect of the present invention, there is provided a method of manufacture of a frame of an offshore renewable energy system mounting platform, the frame comprising: three or more lateral braces and a corresponding quantity of vertex members, each said vertex member arranged to affix adjacent ends of two said lateral braces to form a planar base of the frame, the lateral braces each forming a corresponding edge of said base; a plurality of upright braces equal to the quantity of lateral braces, each of the upright braces arranged to engage a corresponding vertex member to form upright edges of the frame extending from the base at an upright angle relative to the planar base; and a single transition piece arranged to affix the upright braces at the upright angle, the transition piece forming an apex of the frame; the method comprising the steps of:
a. positioning a vertical tower having upright brace engaging surfaces arranged to engage a corresponding said upright brace of the frame at the upright angle;
b. positioning each of a plurality of lateral brace supports at a corresponding ground position relative to the upright brace engaging surfaces, such that each lateral brace support is arranged to support a corresponding said lateral brace to form the base;
c. supporting each said lateral brace using a corresponding said lateral brace support at the corresponding ground position;
d. engaging adjacent ends of two said lateral braces with a corresponding vertex member to form the base;
e. engaging a first end of each upright brace with a corresponding vertex member, and a surface of each said upright brace with a corresponding upright brace engaging surface of the tower; and
f. affixing the transition piece to second ends of each of the engaged upright braces, to form an assembled frame.

In preferable embodiments, the method of the second aspect may be performed using the assembly kit of the first aspect.

In preferable embodiments, step d further comprises permanently affixing said ends to the corresponding vertex member. Step e preferably further comprises permanently affixing said first ends to the corresponding vertex member. Step f preferably further comprises permanently affixing said second ends to the transition piece. Said affixing is preferably performed by welding.

In some preferable embodiments, step d further comprises, before said permanent affixing, surrounding joints between said ends to the corresponding vertex member with a habitat enclosure, the habitat enclosure defining an enclosed welding space about the circumference of said joints. In some preferable embodiments, step e further comprises, before said permanent affixing, surrounding joints between said first ends and the corresponding vertex member with a said habitat enclosure. In some preferable embodiments, step f further comprises, before said permanent affixing, surrounding joints between said second ends and the transition piece with a habitat enclosure. The habitat enclosure is preferably as described herein in relation to the first aspect. In each case steps d, e and f may in some embodiments further comprise, after said permanent affixing, dismantling each habitat enclosure.

In preferable embodiments, the method further comprises the steps of:
g. transporting the assembled frame to a first location in a body of water; and
h. mounting a renewable energy system onto the transition piece of the assembled frame.

Step g, in some embodiments, preferably further comprises supporting each of the lateral braces of the assembled frame on a corresponding self-propelled modular transporter (SPMT). It will be appreciated that in some embodiments, each lateral brace may be, or comprise, an SPMT.

In most preferable embodiments, step g further comprises either: loading the assembled platform onto a marine transport vessel; or floating the frame on the body of water. In embodiments, wherein step g comprises floating the frame on the body of water, step g preferably further comprises temporarily tethering the assembled frame to a bed of the body of water; and wherein step h further comprises, after mounting the renewable energy system, untethering the assembled frame from the bed of the body of water.

In preferable embodiments, the method further comprises the step of transporting the assembled frame to a desired deployment position on said body of water.

In accordance with another aspect of the present invention, there is provided a method of manufacture of a frame of an offshore renewable energy system mounting platform, the frame comprising: three or more lateral braces and a corresponding quantity of vertex members, each said vertex member arranged to affix adjacent ends of two said lateral braces to form a planar base of the frame, the lateral braces each forming a corresponding edge of said base; a plurality of upright braces equal to the quantity of lateral braces, each of the upright braces arranged to engage a corresponding vertex member to form upright edges of the frame extending from the base at an upright angle relative to the planar base; and a single transition piece arranged to affix the upright braces at the upright angle, the transition piece forming an apex of the frame; the method comprising the steps of:
a. positioning a vertical tower having upright brace engaging surfaces arranged to engage a corresponding said upright brace of the frame at the upright angle;
b. positioning each of a plurality of vertex member supports at a corresponding ground position relative to the upright brace engaging surfaces, such that each vertex member support is arranged to support a corresponding vertex member;
c. supporting each said vertex member using a corresponding vertex member support at the corresponding ground position;
d. positioning each of a plurality of lateral brace supports at a corresponding ground position relative to the vertex members, such that each lateral brace support is arranged to support a corresponding said lateral brace to form the base;
e. supporting each said lateral brace using a corresponding said lateral brace support at the corresponding ground position;
f. engaging adjacent ends of two said lateral braces with a corresponding vertex member to form the base;
g. engaging a first end of each upright brace with a corresponding vertex member, and a surface of each said upright brace with a corresponding upright brace engaging surface of the tower; and
h. affixing the transition piece to second ends of each of the engaged upright braces, to form an assembled frame.

In preferable embodiments, the method of the third aspect may be performed using the assembly kit of the first aspect.

It will be appreciated that step c may be performed after step d in some embodiments.

In accordance with a further aspect of the present invention, there is provided a kit of assembly aids for use in assembling an offshore renewable energy system mounting platform, the assembly aids comprising a plurality of lateral brace supports corresponding to a quantity of lateral braces of a said platform; and a vertical tower; wherein each of the lateral brace supports comprise a lateral brace engaging surface arranged to engage a corresponding said lateral brace such that said lateral brace is supported on a horizontal plane above the ground; and the vertical tower having a plurality of upright brace engaging surfaces, each upright brace engaging surface of the tower positioned to engage a corresponding upright brace of the a said platform, such that each engaged said upright brace is supported by the upright brace engaging surface at an upright angle relative to a horizontal plane of the ground.

It will be appreciated that any features described herein as being suitable for incorporation into one or more aspects or embodiments of the present disclosure are intended to be generalizable across any and all aspects and embodiments of the disclosure.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure.

FIG. 1A is a perspective view of example prefabricated components of a platform frame for use with an example embodiment of an assembly kit, in accordance with an aspect of the present disclosure;

FIG. 1B is an exploded view of an example said frame, in accordance with an aspect of the present disclosure;

FIGS. 2A to 2E show an example assembly sequence of a platform frame using an assembly kit in accordance with the first aspect, in accordance with an aspect of the present disclosure;

FIG. 3 is a plan view of an example assembly site for assembling a platform frame in accordance with the first and second aspects, in accordance with an aspect of the present disclosure;

FIG. 4 depicts a perspective view of each of the distinct components comprised within an example embodiment of an assembly kit in accordance with the first aspect, in an un-assembled state, in accordance with an aspect of the present disclosure;

FIGS. 5A to 5D show a stepwise assembly process for assembly of the frame of FIG. 4, in accordance with an aspect of the present disclosure;

FIGS. 6A to 6D show stepwise assembly and deployment steps following the steps of FIGS. 5A to 5D, in accordance with an aspect of the present disclosure;

FIG. 7 is a close-up perspective view of the assembled frame of FIGS. 6A to 6D following mounting of a wind turbine and prior to deployment, in accordance with an aspect of the present disclosure; and

FIGS. 8A to 8D depicts an alternate stepwise assembly process for assembly of the frame of FIG. 4, in accordance with an aspect of the present disclosure.

### DETAILED DESCRIPTION FOR CARRYING OUT THE INVENTION

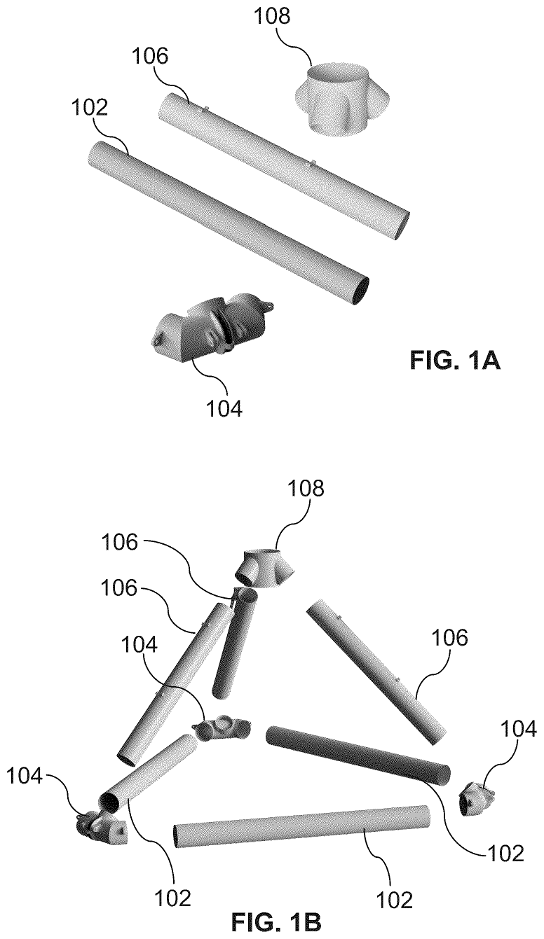

With reference to FIG. 1A, a perspective view of example prefabricated components of a platform frame is shown, for use with an example embodiment of an assembly kit in accordance with the first aspect. The components include only four unique pieces which acts to simplify manufacture, assembly and ongoing maintenance and replacement of parts. The components comprise an elongate cylindrical lateral brace 102 of the frame, a vertex member 104 of the frame, an elongate cylindrical upright brace 106 of the frame, and a transition piece 108 of the frame.

FIG. 1B shows an exploded view of a completed frame 100 having three lateral braces 102 positioned adjacent one another such that the three lateral braces 102 form a triangle. Adjacent ends of the lateral braces 102 are connected using a corresponding vertex member 104 which form vertices of a planar triangular base of the frame 100. Each of the three vertex members 104 comprises two coplanar cylindrical sockets positioned at an angle relative to one another, the sockets sized and shaped to engage complimentary cylindrical ends of the corresponding lateral brace 102. The angle between the two coplanar sockets of the vertex members 104 is such that, when engaged with the corresponding lateral braces 102 to form the planar base of the frame 100, the planar brace forms the desired shape, which in the preferred embodiment shown is a triangle. Therefore, in the embodiment shown the angles between the coplanar sockets of the three vertex members 104 together sum to 180°. In the specific embodiment shown, each individual said angle is 60°.

The vertex members 104 further comprise a third cylindrical socket positioned at an upright angle relative to the two coplanar sockets thereof, and thus relative to the lateral braces 102 when engaged therewith,. The third socket is sized and shaped to receive a cylindrical first end of a corresponding upright brace 106 of the frame. When the vertex member 104 is engaged with a corresponding upright brace 106, the upright brace 106, is positioned at the upright angle relative to the plane of the coplanar sockets and the lateral braces 102. In the specific embodiment 100 shown, the upright angle is 60° and thus together the lateral braces 102, vertex members 104 and the upright braces 106 form a substantially tetrahedral shape. The transition piece 108 comprises three identical cylindrical sockets sized, shaped and angled to engage corresponding cylindrical second ends of the upright braces 106. When engaged with the corresponding cylindrical second ends of the upright braces 106, the transition piece forms an apex of the tetrahedral frame 100.

In use, the frame 100 is used to support a renewable energy system (not shown) thereon, specifically a wind turbine in the particular embodiment shown. Following assembly of the frame 100, the wind turbine is mounted onto the transition piece 108, which comprises an appropriate connector portion on a top surface thereof. After the wind turbine is mounted, the frame is transported to a desired offshore location for deployment in a body of water.

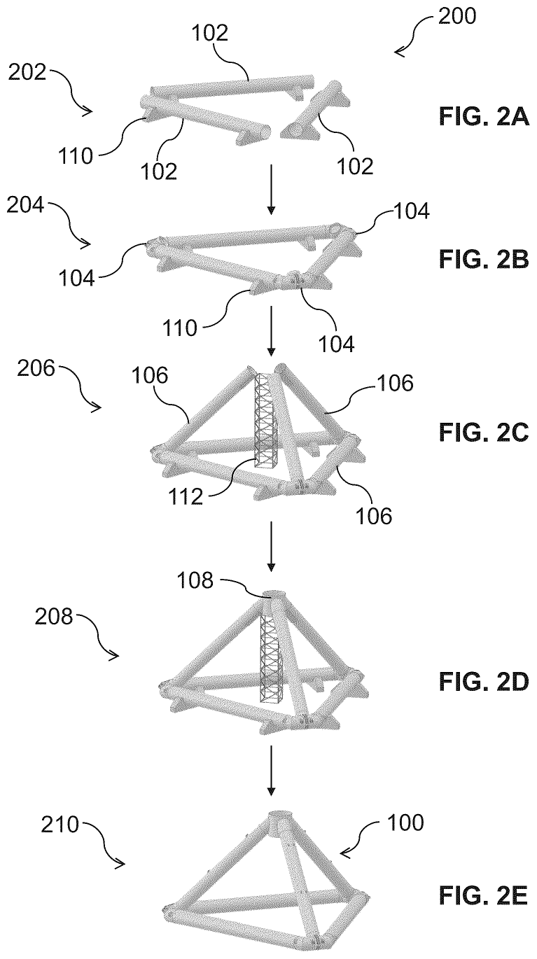

FIGS. 2A to 2E show an example frame assembly process 200 using an assembly kit of the first and third aspects, the process 200 in accordance with the second aspect. FIG. 2A shows an initial step 202 of the process 200 which includes supporting each lateral brace 102 of the frame 100 on a corresponding pair of lateral brace supports 110 of the assembly kit, each of the pair of lateral brace supports 110 positioned proximate an opposite end of the respective lateral brace 102. The lateral brace supports 110 each comprise a curved socket portion sized and shaped to receive a portion of the corresponding lateral brace 102 such that the lateral brace 102 cannot move laterally (perpendicular to the longitudinal axis of the brace 102). The lateral brace supports 110 support the corresponding lateral brace 102 on a horizontal plane above the plane of the ground.

The positioning of the lateral braces 102 on the lateral brace supports 110 facilitates engagement of the vertex members 104 with the respective ends of the corresponding lateral braces 102 in the next stage 204 of the assembly process 200, as shown in FIG. 2B. In this stage, the vertex members 104 and the lateral braces 102 are engaged to form the planar base of the frame 100. Once engaged, the lateral brace supports 110 hold the base of the frame in place while a permanent affixing is applied between the lateral braces 102 and respective vertex members 104. In the specific embodiment shown, the permanent affixing is performed by welding the vertex members 104 and the lateral braces 102 together.

In a subsequent step 206 of the process 200, as shown in FIG. 2C, first ends of the upright braces 106 of the frame 100 are engaged with corresponding sockets of the vertex members 104. The assembly kit comprises a tower 112 having curved upright brace engaging portions which are shaped, sized and angled to accept a portion of the upright braces 106 such that the upright braces 106 are each supported at the upright angle relative to the planar base. A similar affixing is then applied between the upright braces 106 and the vertex members 104 as previously described, facilitated by the upright brace engagement portions of the tower 112.

As a penultimate step 208 in the process 200, shown in FIG. 2D, the sockets of the transition piece 108 of the frame 100 are engaged with the corresponding upright braces 106. This process is facilitated by the upright brace engaging portions of the tower 112 which support the upright braces 106 at the upright angle to ease insertion of second ends of said braces into a correspond socket of the transition piece 108. A similar affixing is then applied between the upright braces 106 and the transition piece 108 as previously described, facilitated by the upright brace engagement portions of the tower 112.

As a final step 210 in the process 200, shown in FIG. 2E, the assembly aids (the lateral brace supports 110 and the tower 112) are removed to leave the complete assembled frame 100.

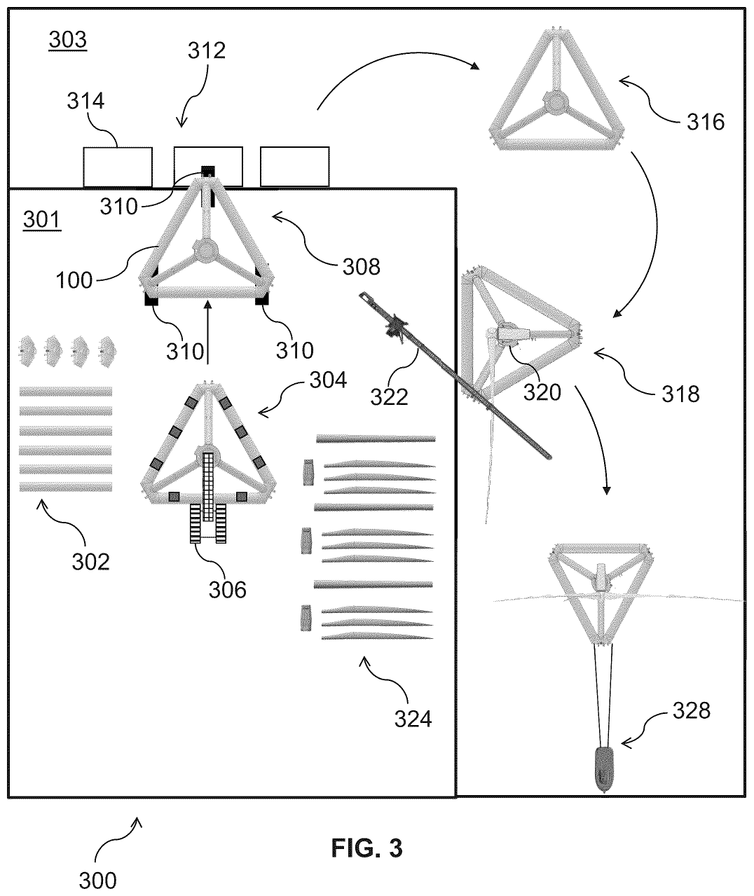

A plan view of example regions of an assembly site 300 is shown in FIG. 3, taking the form of a marshalling yard, having a landmass 301 positioned adjacent a body of water 303, the assembly site 300 used for assembly of a frame 100 using an assembly kit of the first aspect, and in accordance with a method of the second aspect. The site 300 includes a parts region 302 housing individual parts for one or more frames 100 as described. The frame parts may then be assembled in accordance with FIGS. 2A to 2E at an assembly region 304 assisted by a crane 306. Following assembly, the completed frame is then moved to an initial loading region 308 by one or more self-propelled modular transporters (SPMTs) placed beneath the base of the frame 100. The frame 100 is initially loaded 312 onto a floating platform 314 floating in the body of water 303, before being transported by the floating platform 314 away from the landmass 301 and into a deeper region 316 of the body of water 303, where the frame 100 is removed from the floating platform 316 and floated on the surface of the body of water 303. The floating frame 100 is then transported by tug boat to a wind turbine mounting region 318, where a wind turbine 320 is mounted to the transition piece of the frame 100 using a crane 322, the wind turbine 320 having been assembled separately on the assembly site 300 at a wind turbine assembly region 324. In the embodiment shown, the floating frame 100 is moored to the bed of the body of water 303 at the wind turbine mounting region 318 to provide stability to the frame during mounting. Following mounting of the wind turbine 320 to the transition piece of the frame 100, the floating frame 100 is transported by tug boat to a desired offshore deployment location 328 to be deployed for harnessing wind energy.

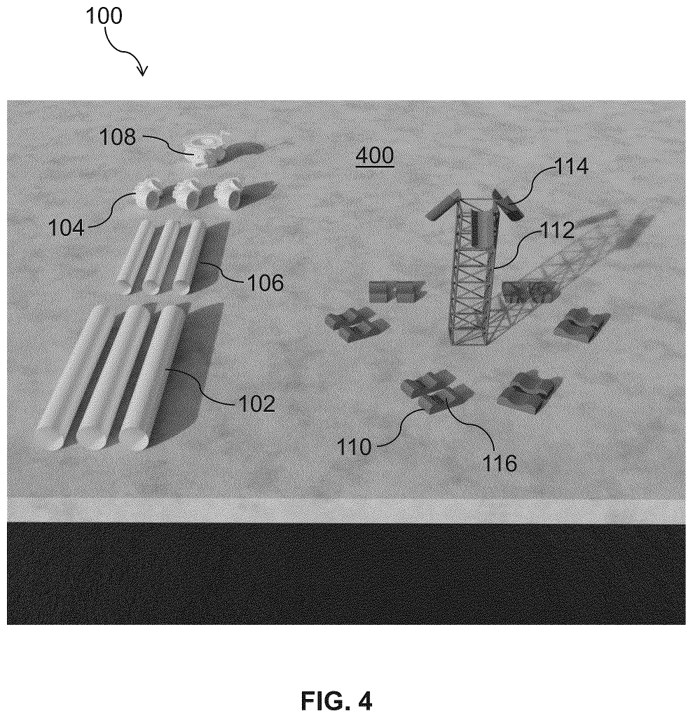

FIG. 4 shows the individual components of an example assembly kit in accordance with the first aspect, positioned at a waterside assembly location 400 ahead of assembly. The initial assembly process as shown in FIG. 4 comprises positioning the vertical tower 112 of the assembly kit, and positioning each of the lateral brace supports 110 of the assembly kit at a corresponding ground position relative to the curved upright brace engaging surfaces 114 of the tower 112, such that each of the lateral brace supports 110 is positioned to support a corresponding said lateral brace 102 to form the triangular base of the frame.

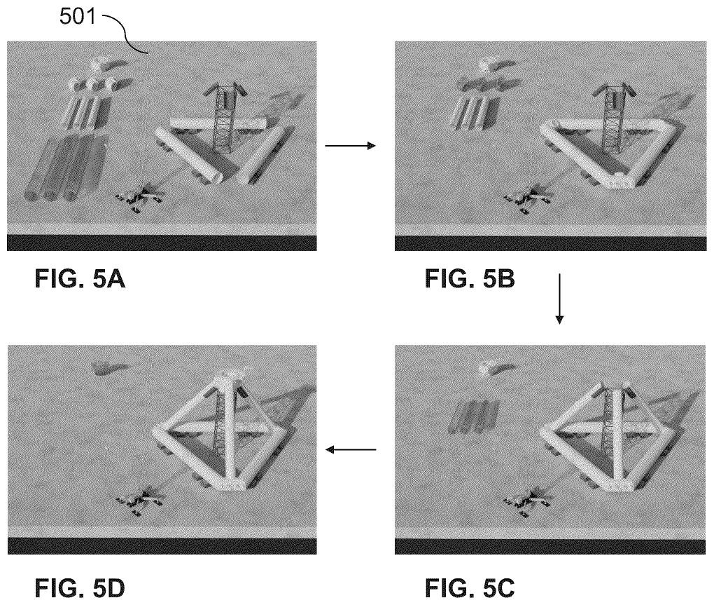

FIGS. 5A to 5D show further individual steps of the assembly process in accordance with the second aspect, the steps including supporting each said lateral brace 102 using a lateral brace engaging portion 116 of a corresponding said lateral brace support 110 at the ground position as shown in FIG. 5A. The steps further include engaging adjacent ends of two said lateral braces 102 with a corresponding vertex member 104 to form the planar base of the frame 100 as shown in FIG. 5B. FIG. 5C shows a further step in the process, which includes engaging a first end of each upright brace 106 with a corresponding vertex member 104, and a surface of each said upright brace with a corresponding upright brace engaging surface 114 of the tower 112, such that the upright brace is supported at the upright angle. The assembly process further comprises affixing the transition piece 108 using a crane 501 to second ends of each of the engaged upright braces 106, to form an assembled frame, as shown in FIG. 5D. Each engagement step, in the particular embodiment shown, comprises a welding step in which each of the engaged components are welded together while supported by the corresponding assembly aids (lateral brace supports 110 and the tower 112).

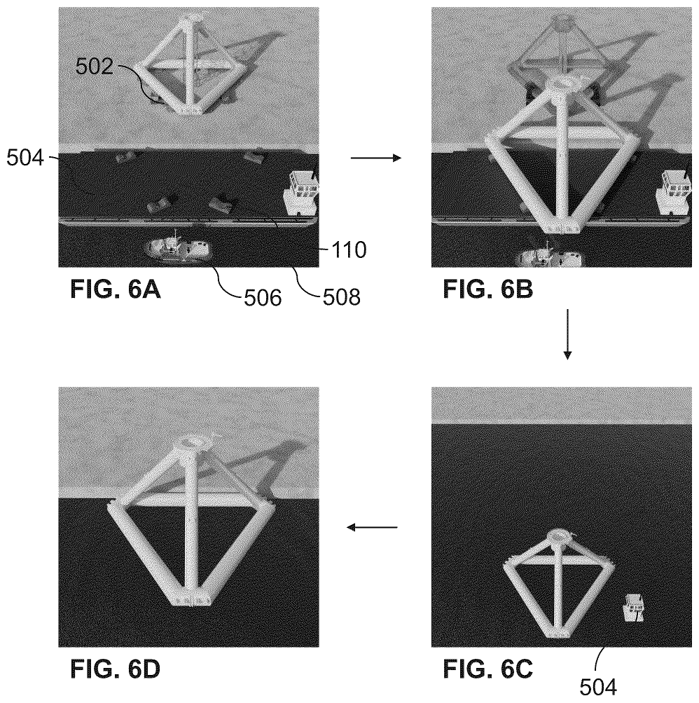

FIGS. 6A to 6D show further steps in an assembly process in accordance with the second aspect. In particular, FIG. 6D shows the step of supporting the base of the assembled frame, particularly the lateral braces thereof, on a self-propelled modular transporter (SPMT) 502 for transport away from the assembly site toward a body of water 508 and onto a floating platform 504. Lateral brace supports 110 are positioned on the floating platform 504 for supporting the assembled frame thereon. The transport apparatus further comprises a tug boat 506 for assisting in loading the frame onto the floating platform 504 as shown in FIG. 6B. The frame is then transported to a deeper region of the body of water 508, as shown in FIG. 6C, where the platform 504 is submerged to leave the assembled frame floating on the surface of the body of water 508. The floating frame is then transported back to land as shown in FIG. 6D in preparation for mounting a renewable energy system, in this particular case a wind turbine, onto the transition piece of the assembled frame.

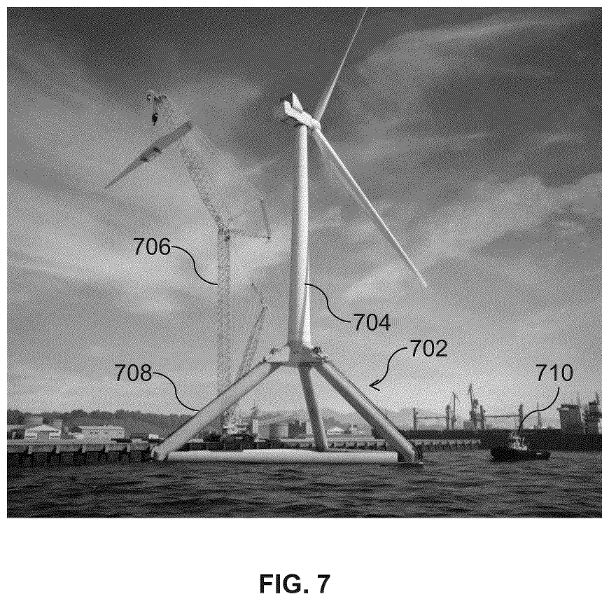

The completed frame 702 following the mounting of a wind turbine 704 onto the transition piece of the frame using a crane 706, is shown in FIG. 7. In order to provide stability during said mounting, a mooring system 708, which in this case comprises a plurality of mooring lines tethering the frame to the bed of the body of water, is used to stabilize the floating frame in the body of water. After mounting, a tug boat 710 is then used for transporting the floating assembled frame to a desired deployment position on the body of water.

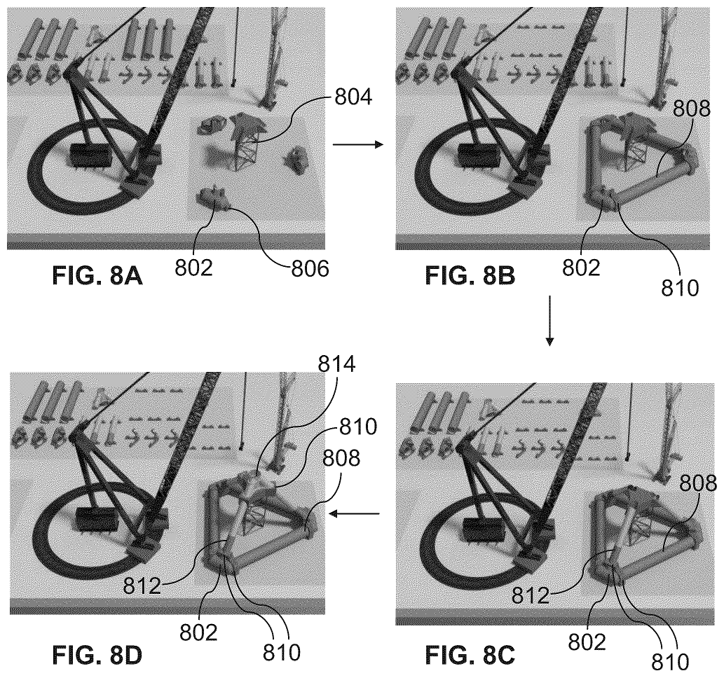

FIGS. 8A to 8D show steps in the assembly of a platform frame as described in relation to earlier embodiments, the steps being similar to those described in relation to FIG. 5A to 5D. In the assembly sequence shown in FIGS. 8A to 8D, the vertex members 802 of the platform frame are positioned about the erected vertical tower 804 such that lateral connections on the vertex members 802 are aligned with a corresponding lateral connection of another said vertex member 802, and an upright connection thereof is aligned with a corresponding upright brace engaging surface of the vertical tower 804 (as seen in FIG. 8A). In the embodiment shown, each vertex member is supported above the surface of the ground on a vertex member support 806.

As seen in FIG. 8B, each lateral brace 808 of the platform frame is then engaged at both ends thereof with corresponding vertex members 802. A habitat enclosure 810 is then constructed around the circumference of each join between a lateral brace and a vertex member.

FIG. 8C shows each upright brace 812 of the platform frame is then supported on a corresponding upright brace engaging surface of the tower 804 and engaged at a first end thereof with a corresponding vertex member 802. A habitat enclosure 810 is then constructed around the circumference of each join between an upright brace and a vertex member.

As shown in FIG. 8D, the transition piece 814 is supported on the tower 804 and engaged with corresponding upright braces 812. A habitat enclosure 810 is then constructed around the circumference of each join between an upright brace and the transition piece 814.

The habitat enclosures 810 act to provide complete protection around the circumference of a lateral or upright brace joint during welding, while additionally improving accessibility to all areas of the joint for welding. Access to the habitat enclosure 810 for welding will be understood to be any suitable form of access, and where habitat enclosures are located at joins between the upright braces and the transition piece, access may in some embodiments be facilitated by an elevator located on the tower.

In the embodiments described herein, the frame comprises only ten primary steel components with only four distinct parts. The transition piece and vertex members/corner nodes are formed of a rolled tube and welded plate structure, such that manufacture thereof integrates simply into existing factory supply chains. The brace elements are rolled tube with some small cast features, and can therefore easily integrate into a wind turbine tower supply chain. Thus, the present frame provides simple fabrication methods which enable automated, volume manufacture in the supply chain—providing high quality at low cost and maximising use established and safe processes. The present assembly embodiment provides flexibility to prioritise local content or global cost base. Using distributed manufacturing can enable increased quantities and low supplier dependency and risk.

The present assembly is shown as being performed at an outdoor marshalling yard. This arrangement provides larger tolerance window, minimising defects and re-work. The specific frame confirmation minimises welding—only 12 semi-automatic orbital outdoor welds. The present assembly aids provide safe access and support for welding operations, and allow streamlined planning of marshalling activities and reduction in yard requirements.

The presently described rapid assembly methodology reduces the space requirements for an assembly yard, and reduces the number of simultaneous assembly positions needed for a given throughput. The modular components of the described assembly kit are easy to store and can be stacked on a transport frame to further reduce laydown space requirements. The wind turbine mounting process described the use of a floating frame with the turbine installed is less than 5 m, which opens up maximum facility options, in particular the facility can be closer to the assembly project. The present process is designed to be repeatable at scale and may be easily optimised as part of a mass assembly line.

The presently described assembly aids (lateral brace supports and tower) can easily be positioned on a quayside to enable repeatable and rapid assembly. The assembly aids preferably engage with low cost features incorporated into the primary steel components of the braces, vertex members and transition piece. The assembly aids also preferably incorporate platforms and other access and welfare features for assembly personnel (e.g. stairs, lifts, toilets) to provide a safe working environment. The use of the present assembly aids preferably eliminates and/or minimises the use of carnage to maintain components in position during welding, and scaffolding.

Mooring of the frame ahead of mounting the wind turbine as described preferably provides a stable base for lifting operations, minimising downtime due to weather causing motions on the structure. The central positioning of the turbine on the structure improves stability and negates the need for ballasting operations during and between lifts. Asymmetric turbine placements require careful control of ballasting during lifting operations to maintain level trim.

In use, the cylindrical braces can provide an aerodynamic and hydrodynamic character to the frame, with the tetrahedral shape providing optimal stability to the mounted wind turbine in use, and the frame providing minimal drag against oncoming wind or waves. In use, the embodiment described comprises buoyant lateral braces, which may be adjustably buoyant, and wherein the base of the platform is submerged beneath the surface of the body of water using a mooring system of adjustable length, with the transition piece remaining above the surface of the body of water. The buoyancy of the lateral braces preferably optimises tension in the mooring system such that maximum stability is conferred upon the frame in use in supporting the wind turbine.

Other embodiments will be envisaged, for example wherein the frame comprises buoyancy tanks affixed thereto.

Further embodiments within the scope of the present disclosure may be envisaged that have not been described above, for example, there may be any combination of renewable energy convertors on the frame/platform as described herein. The example embodiment is shown supporting a wind turbine, but any suitable renewable energy converter may be supported, for example a wave energy converter, or any combination of said suitable renewable energy converters. One, multiple or all vertices of the platform may support the renewable energy convertor. In the example described herein, the platform comprises lateral braces which are all identical and upright braces which are all identical. Embodiments will be appreciated, wherein the platform comprises any suitable lateral and upright structural members having a mating connection therebetween, suitable for use with the described assembly aids. The frame in the example described takes a tetrahedral form, conferring a rigidity and stability inherent to such a form. Embodiments will be appreciated, wherein the frame may take any suitable form within the scope of the appended claims. This disclosure is not limited to the specific examples or structures illustrated.

As may be recognized by those of ordinary skill in the art based on the teachings herein, numerous changes and modifications may be made to the above-described and other embodiments of the present disclosure without departing from the scope of the disclosure. The components of the platform assembly as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the platform assembly may include more or fewer components or features than the embodiments as described and illustrated herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of the platform assembly that “comprises,” “has,” “includes,” or “contains” one or more features possesses those one or more features, but is not limited to possessing only those one or more features. Furthermore, a platform assembly, device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations

What is claimed is:

1. An assembly kit for assembling an offshore renewable energy system mounting platform, the kit comprising:
a frame for a renewable energy system mounting platform, the frame comprising:
three or more elongate lateral braces;
a plurality of elongate upright braces, equal to the quantity of lateral braces;
a plurality of vertex members equal to the quantity of lateral braces, each vertex member arranged to affix two said lateral braces at a corresponding end thereof such that the lateral braces and the vertex members form a substantially planar base of the frame; and wherein the vertex members are each further arranged to engage a first end of a corresponding upright brace such that said upright brace is affixed to the base at an upright angle relative thereto;
the frame further comprising a single transition piece arranged to engage a second end of each of the upright braces when positioned at said upright angle, the transition piece thereby forming a fixed apex of the frame, to form an assembled frame;
the kit further comprising assembly aids, the assembly aids comprising:
a plurality of lateral brace supports corresponding to the quantity of lateral braces; and
a vertical tower;
wherein each of the lateral brace supports comprise a lateral brace engaging surface arranged to engage a corresponding lateral brace such that said lateral brace is supported on a horizontal plane above the ground;
and the vertical tower having a plurality of upright brace engaging surfaces, each upright brace engaging surface of the tower positioned to engage a corresponding upright brace such that each engaged upright brace is supported by the upright brace engaging surface at the upright angle.

2. The assembly kit of claim 1, wherein the lateral brace engaging surface conforms to a shape of the corresponding lateral brace; and wherein the upright brace engaging surface confirms to a shape of the corresponding upright brace.

3. The assembly kit of claim 2, wherein said shape of the lateral brace and said shape of the upright brace is one selected from the group: curved; cylindrical.

4. The assembly kit of claim 1, wherein the assembly aids further comprise:
one or more welding stations arranged to be positioned at each of the vertex members when engaged with said corresponding lateral braces, wherein each lateral brace is supported on a corresponding lateral brace support.

5. The assembly kit of claim 1, wherein the assembly kit further comprises a plurality of self-propelled modular transporters (SPMT) corresponding to the quantity of lateral braces, wherein each SPMT is arranged to support a corresponding lateral brace of the frame on a horizontal plane above the ground, and further arranged to, while engaged with said lateral brace, transport the assembled frame.

6. The assembly kit as claimed of claim 1, wherein each of the lateral brace supports is arranged to, while engaged with said lateral brace, transport the assembled frame.

7. The assembly kit of claim 1, wherein the tower comprises an upper platform arranged to support assembly personnel.

8. The assembly kit of claim 1, wherein the transition piece is arranged to support a renewable energy system thereon.

9. The assembly kit of claim 8, wherein the renewable energy system comprises at least one of a wave energy converter and a wind turbine.

10. The assembly kit of claim 1, comprising three lateral braces.

11. The assembly kit of claim 1, wherein the frame, when assembled, comprises a tetrahedral shape.

12. The assembly kit of claim 1, wherein each of the lateral braces are identical, each of the upright braces are identical, and each of the vertex members are identical.

13. The assembly kit of claim 1, wherein each vertex member comprises two coplanar socket members each arranged to receive an end of a corresponding lateral brace on a common plane, and an angled socket member arranged to receive a first end of a corresponding upright brace at the upright angle relative to said plane.

14. The assembly kit of claim 1, wherein the assembly kit comprises a plurality of lateral brace supports for each corresponding lateral brace.

15. A method of manufacturing a frame for an offshore renewable energy system mounting platform, the frame comprising:
three or more lateral braces and a corresponding quantity of vertex members, each vertex member arranged to affix adjacent ends of two of the lateral braces to form a planar base of the frame, the lateral braces each forming a corresponding edge of said base; a plurality of upright braces equal to the quantity of lateral braces, each of the upright braces arranged to engage a corresponding vertex member to form upright edges of the frame extending from the base at an upright angle relative to the planar base; and a single transition piece arranged to affix the upright braces at the upright angle, the transition piece forming an apex of the frame;
the method comprising the steps of:
positioning a vertical tower having upright brace engaging surfaces arranged to engage a corresponding upright brace of the frame at the upright angle;
positioning each of a plurality of lateral brace supports at a corresponding ground position relative to the upright brace engaging surfaces, such that each lateral brace support is arranged to support a corresponding said lateral brace to form the base;
supporting each said lateral brace using a corresponding said lateral brace support at the corresponding ground position;
engaging adjacent ends of two said lateral braces with a corresponding vertex member to form the base;
engaging a first end of each upright brace with a corresponding vertex member, and a surface of each said upright brace with a corresponding upright brace engaging surface of the tower; and
affixing the transition piece to second ends of each of the engaged upright braces, to form an assembled frame.

16. The method of claim 15, wherein the method is performed using the assembly kit of claim 1.

17. The method of claim 15, further comprising permanently affixing the ends of the lateral braces to the corresponding vertex member.

18. The method of claim 15, further comprising permanently affixing the first end of the upright brace to the corresponding vertex member.

19. The method of claim 15, further comprising permanently affixing the second ends of the upright braces to the transition piece to form an assembled frame.

20. The method of claim 17, wherein affixing is performed by welding.

21. The method of claim 15, further comprising:
transporting the assembled frame to a first location in a body of water; and
mounting a renewable energy system onto the transition piece of the assembled frame.

22. The method of claim 21, wherein the step of transporting further comprises:
supporting each of the lateral braces of the assembled frame on a corresponding self-propelled modular transporter (SPMT).

23. The method of claim 22, further comprising at least one of loading the assembled platform onto a marine transport vessel and floating the frame on the body of water.

24. The method of claim 23, wherein floating the frame on the body of water further comprises:
temporarily tethering the assembled frame to a bed of the body of water, and
wherein mounting a renewable energy system onto a transition piece of the assembled frame further comprises, after mounting the renewable energy system, untethering the assembled frame from the bed of the body of water.

25. The method of claim 24, further comprising the step of:
transporting the assembled frame to a desired deployment position on said body of water.
